(19) United States
(12) Patent Application Publication
(10) Pub. No.: US 2004/0231402 A1
(43) Pub. Date: Nov. 25, 2004

(54) Sensor element, in particular an oil condition sensor element, and a fluid sensor having a sensor element of this type

(76) Inventors: Heinz Eisenschmid, Ditzingen-Hirschlanden (DE); Michael Stumber, Korntal-Muenchingen (DE)

Correspondence Address: KENYON & KENYON, ONE BROADWAY, NEW YORK, NY, 10004, US

(21) Appl. No.: 10/802,653

(22) Filed: Mar. 17, 2004

(30) Foreign Application Priority Data
Mar. 17, 2003 (DE) 103 11 521.8

(51) Int. Cl. G01N 11/00

(52) U.S. Cl. 73/53.01

(57) ABSTRACT

A sensor element is provided, in particular an oil condition sensor element, having a sensing area that is in contact with a fluid, in particular an oil. During operation, the sensing area is able to detect a measured variable characterizing a physical and/or chemical property of the fluid. For this purpose, at least some regions of the sensing area have a metal plating or a metallic structure that is applied directly to a plastic surface. In addition, a fluid sensor is provided having a sensor element of the type described above, as well as an additional sensor element that differs from the first sensor element, this additional sensor element being able to detect a measured variable characterizing a physical and/or chemical property of the fluid during operation.

### FIELD OF THE INVENTION

The present invention relates to a sensor element, in particular an oil condition sensor element, as well as a fluid sensor having a sensor element of this type.

### BACKGROUND INFORMATION

Conventional oil condition sensors may include not only an extrusion-coated pressed screen for measuring electrical properties of an oil, such as a dielectric constant or a conductivity or also a level in a reservoir, but also additional components for measuring oil viscosity, a temperature sensor having a negative temperature coefficient (NTC resistor), a p.c. board conductor with evaluation electronics mounted on it, and a multi-part housing having a connector.

### SUMMARY

An exemplary embodiment of the present invention provides a sensor element, in particular an oil condition sensor element, as well as a fluid sensor having a sensor element of this type, the layout of which is simpler than that of the related art due to a smaller number of individual components, as well as a simplified and more cost-effective manufacturing process.

The sensor element according to an exemplary embodiment of the present invention and the fluid sensor according to an exemplary embodiment of the present invention having a sensor element of this type, have the advantage over the related art in that fewer components and fewer assembly steps are necessary to manufacture them, thus increasing reliability, i.e., reducing fault susceptibility, and lowering production variations. In particular, the use of MID (molded interconnect device) technology makes it possible to eliminate the separate p.c. board that may otherwise be necessary, and also makes it possible to integrate the latter's function, for example, on the cover of the base member or inside the hollow member.

This also overcomes the problem that the p.c. board concept shown in FIG. 1 is comparatively susceptible to faults when temperatures fluctuate a great deal, as may occur during operation at the installation site.

Another advantage is that the EMC (electromagnetic compatibility) stability of the sensor element or fluid sensor may be substantially increased in the plastic hollow member via suitable metal plating, or by providing, or integrating, additional shielding components. In particular, a hollow member of this type makes it possible to shield the sensing area against mechanical disturbances and/or electromagnetic fields.

In the case of the MID technology mentioned above for applying the metal plating or metallic structure to the plastic surface, another advantage lies in the fact that selective metal plating of the plastic surface makes it possible to produce conductors such as wires or p.c. boards, connectors or even the sensing area of the sensor element particularly easily and cost-effectively.

When using the MID technology, it may be advantageous to use a 2-component injection-molded plastic having a metal-platable component, the metal plating or metallic structure being produced by currentless or galvanic deposition of a metal, or by hot stamping on the plastic surface.

Additionally, the MID technology makes it possible to integrate functional structural components such as the sensing area into the housing of the sensor element or the fluid sensor. Electrical connections or structural components such as conductors, connectors, resistors, and capacitors may be integrated into a housing of this type, or produced on its surface, in the form of an injection-molded plastic component. In particular, this makes it possible to produce conventional capacitor structures from the related art, such as interdigital capacitor structures, on the surface of the plastic component. Capacitor structures of this type may be suitable for level measurements and/or for measuring electrical properties of the fluid with which the sensor element is in contact in the sensing area during operation.

The sensor element according to an exemplary embodiment of the present invention and the fluid sensor according to an exemplary embodiment of the present invention also provides, in addition to the cost savings and increased reliability mentioned above, greater freedom of design in selecting an optimum geometry for the sensing area, for example, for level measurements. This makes it possible to optimize the structure of the metal plating applied to the plastic surface in the sensing area or the design of the metallic structure within a comparatively broad range, in particular in the form of an interdigital capacitor, with a view toward reducing the adherence of the tested fluid to the metal plating or metallic structure, which is caused by capillary forces and adhesion. This also reduces measuring errors and, if the metallic structure is designed as an interdigital capacitor, makes it possible to increase the latter's capacitance.

### BRIEF DESCRIPTION OF THE DRAWINGS

FIG. 1 shows an exploded view of an oil condition sensor according to the related art.

FIG. 2 shows a perspective view of an exemplary embodiment of a fluid sensor according to the present invention designed as an oil condition sensor.

FIG. 3 shows a schematic diagram of one section of a sensing area of a sensor element according to the present invention.

FIG. 4 shows an alternative exemplary embodiment of one section of a sensing area of a sensor element of the present invention.

FIG. 5 shows an alternative exemplary embodiment of one section of a sensing area of a sensor element of the present invention.

FIG. 6 shows an alternative exemplary embodiment of one section of a sensing area of a sensor element of the present invention.

FIG. 7 shows an alternative exemplary embodiment of one section of a sensing area of a sensor element of the present invention.

FIG. 8 shows a cross-sectional view of a fluid sensor having a further sensor element according to the present invention.

### DETAILED DESCRIPTION

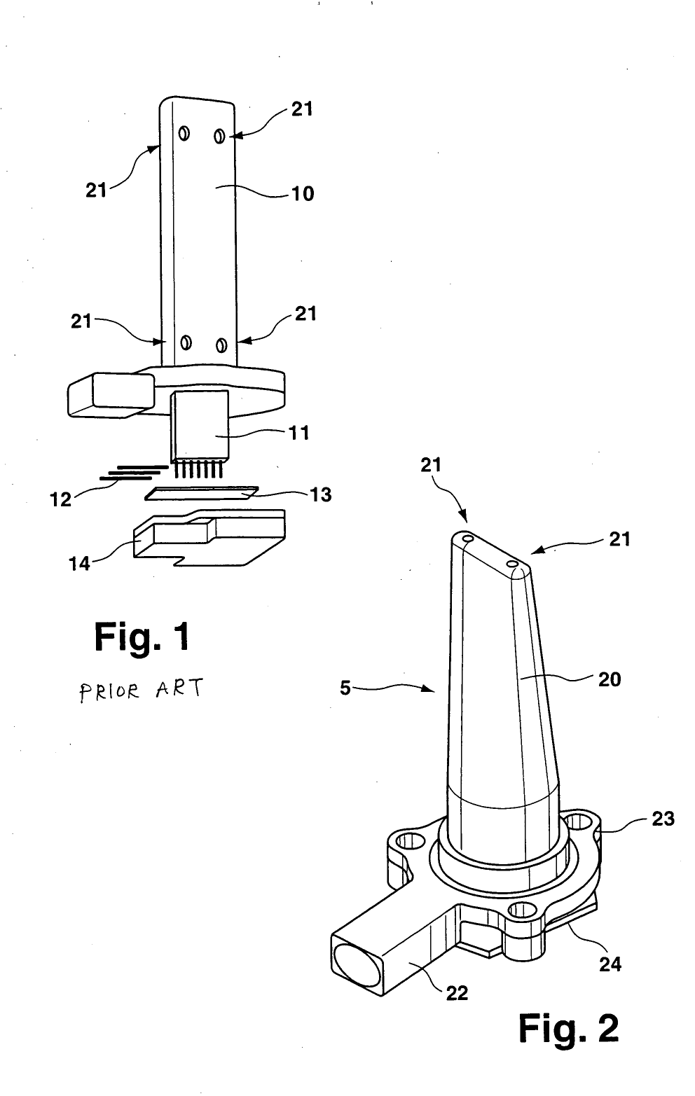

FIG. 1 shows an exploded view of a conventional oil condition sensor, including a cover 10 in the form of a hollow member made of a plastic injection-molded part having multiple inlet openings 21 for the oil to be analyzed; a pressed screen 11 (or a capacitance measuring board) in the form of a vertically projecting structure which may be used for the capacitive measurement of the oil level in a reservoir; contact pins 12 for connecting pressed screen 11 (or capacitance measuring board) to a connector; a p.c. board 13 having evaluation electronics, i.e., for example ASIC and/or SMD components; and a metal cover 14. A reference capacitor for calibrating the oil condition sensor according to FIG. 1 is provided in a vicinity of cover 14. Contact pins 12 are used to relay the output signal of the oil condition sensor according to FIG. 1 to external components via the connector.

In addition to pressed screen 11 (or capacitance measuring board) for capacitive level measurements, additional sensor elements for measuring temperature and/or viscosity are also connected to p.c. board 13, which holds the evaluation circuit.

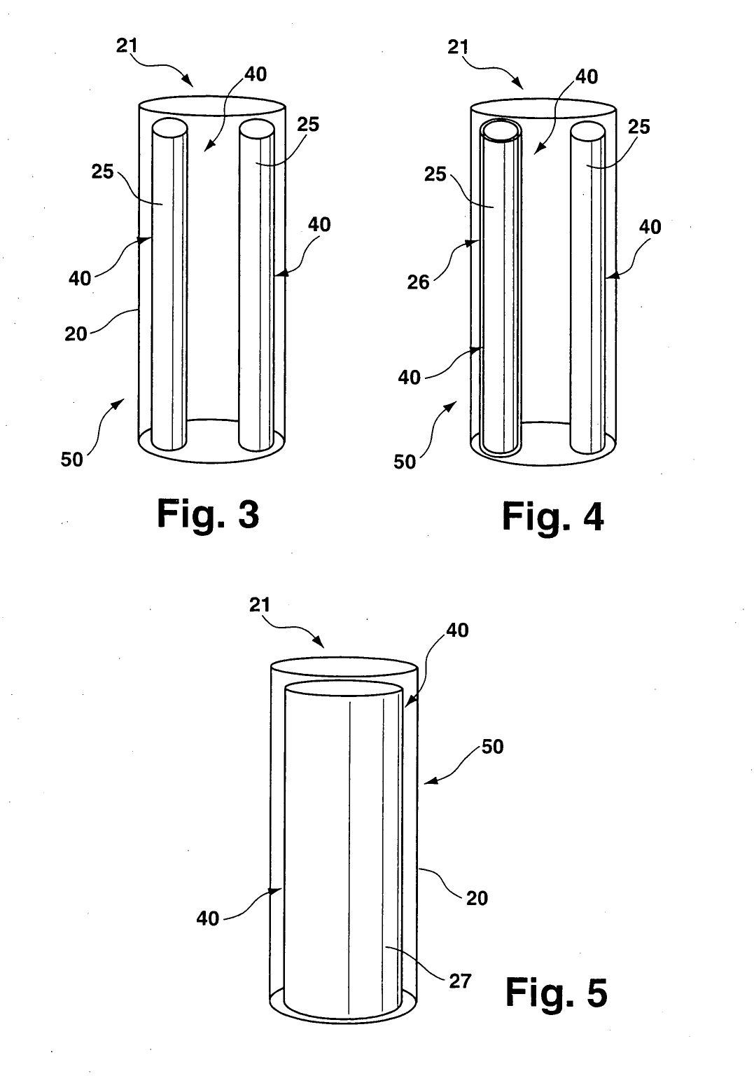

As an exemplary embodiment of the present invention, FIG. 2 illustrates an oil condition sensor in the form of fluid sensor 5. A base member 23 is provided in the form of a carrying member made of metal, which is connected to a hollow member 20 made of two-component injection-molded plastic having a metal-platable component. Hollow member 20 has inlet openings 21 that allow a fluid, such as an oil of a motor vehicle, to enter the interior of hollow member 20, for example from the oil pan. A cover 24 in the form of a plastic plate is provided on the side of base member 23 facing away from hollow member 20. Fluid sensor 5 according to FIG. 2 also has a plug connection 22 with which, via a suitable connector and external structural components, a measured variable provided by fluid sensor 5 is detectable. A sensing area 50 (shown in FIG. 3, for example), at least part of which is in contact with the fluid at least temporarily during operation of fluid sensor 5 and which may be used to detect at least one measured variable characterizing a physical, in particular electrical, and/or chemical, property of the fluid, is provided inside hollow member 20. This measured variable is, for example, a dielectric constant of the fluid, an electrical or thermal conductivity of the fluid, and/or a capacitance for the capacitive measurement of the fluid level in a reservoir, such as an oil pan.

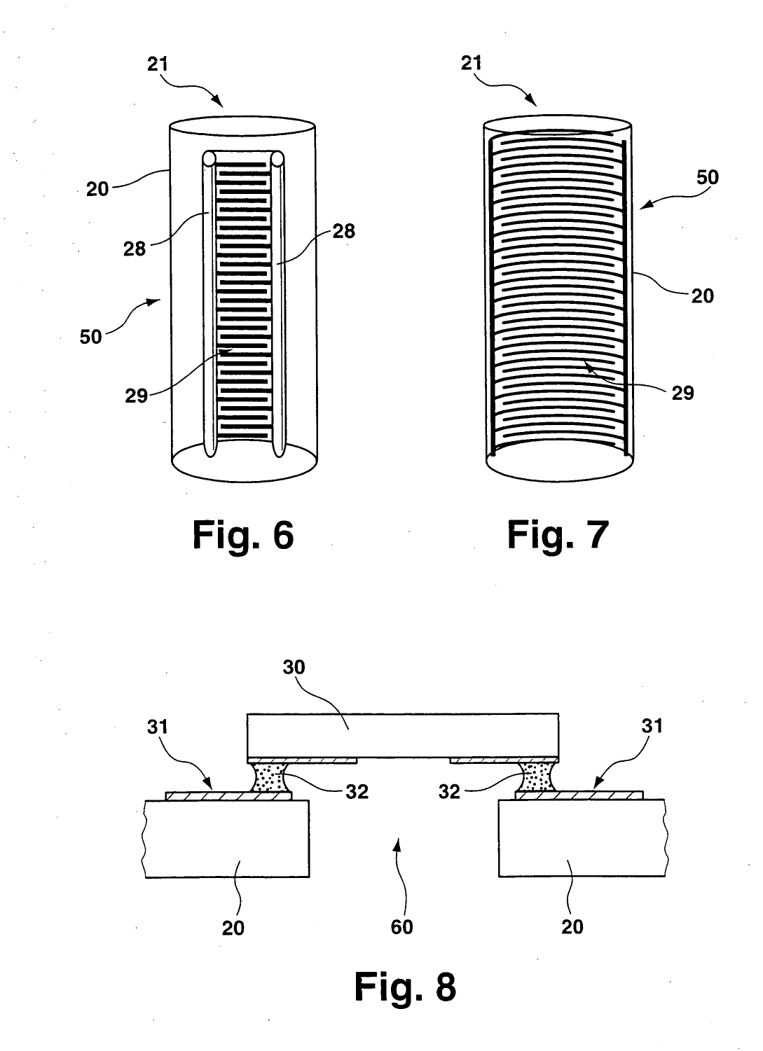

Specifically, in at least some areas, a metal plating 40 applied directly to the plastic surface of hollow member 20 (as shown in FIG. 3, for example), using MID technology, is provided in sensing area 50 inside hollow member 20, in particular in the form of printed conductors or metallic structure 29 (as shown in FIG. 6, for example), which may be produced by currentless or galvanic deposition of a metal onto the plastic surface or, alternatively, by hot stamping. Designing at least some areas of metallic structure 29 in the form of an interdigital capacitor may also be possible.

On the whole, hollow member 20, together with base member 23 and cover 24, forms the housing that shields sensing area 50 against mechanical effects, and, if a suitable material is selected for hollow member 20 and/or shielding structures are additionally applied, also shields against electromagnetic fields. In this manner, hollow member 20 may increase the electromagnetic compatibility of fluid sensor 5.

In an exemplary design, hollow member 20 and cover 24 are each made of an injection-moldable plastic, in particular a 2-component injection-molded plastic having a metal-platable component.

FIG. 3 illustrates an exemplary embodiment of the design of sensing area 50 of fluid sensor 5 shown in FIG. 2.

In FIG. 3, a simplified view of hollow member 20 in the form of a hollow cylinder is shown, the inside surface of which is metal plated over its entire area. If EMC is less of a concern, this metal plating may also be omitted, if necessary. Furthermore, two parallel rods 25, which are spaced some distance apart, are provided inside this hollow member 20 designed as a hollow cylinder, and the rods are each made of plastic, at least on the surface. Rods 25 may also be designed as prisms or hollow cylinders and have a cross section that deviates from FIG. 3. Rods 25 are also provided with metal plating 40 over the entire plastic surface, i.e., the two rods 25 according to FIG. 3 together form a capacitor whose capacitance changes when the two rods 25 are immersed in a fluid such as oil. This change in capacitance makes it possible to detect a level of a physical or chemical property of the oil, such as its dielectric constant or conductivity.

FIG. 4 shows an alternative embodiment to the exemplary embodiment illustrated in FIG. 3, the surface of one of the two rods 25 according to FIG. 3 being additionally provided with an additional insulation layer 26, made for example of plastic and applied to metal plating 40. In this way, the measured capacitance may be established by the double layer present on the electrode formed in this manner, which is directly dependent on the fill level. Thus, a second rod 25, which is not provided with insulation layer 26, may be omitted in the embodiment shown in FIG. 4. In other respects, the layout in FIG. 3 may not differ from the layout according to FIG. 4.

FIG. 5 shows an additional alternative embodiment to the exemplary embodiments shown in FIGS. 3 and 4. The inside of hollow member 20 may be metal plated over its entire area, and a rod or hollow cylinder 27 may be provided inside hollow member 20, e.g., situated concentrically to hollow member 20, and provided with a metal plating 40 on the surface of its outside facing the inside of hollow member 20. At least the surface of hollow cylinder 27 shown in FIG. 5 may be made of plastic, onto which metal plating 40 is applied directly. In this manner, hollow member 20 and hollow cylinder 27 together form a capacitor whose capacitance is dependent on the physical and/or chemical properties of a fluid into which at least some areas of this capacitor are immersed.

FIG. 6 shows a further alternative embodiment to the exemplary embodiments illustrated in FIG. 3, 4 and 5. A bracket 28, in the form of a plastic plate on whose surface a metallic structure 29 is situated in the form of an interdigital capacitor, may be provided inside hollow member 20, the interior of which is optionally metal plated. In addition, parts of the edge areas of plate 28 are metal plated to allow for electric contacting of interdigital capacitor 29. Furthermore, the inner surface of hollow member 20 may be metal plated over its entire area, in particular with regard to EMC.

FIG. 7 shows another exemplary embodiment of a sensing area 50, the inside of hollow member 20 being provided in this case with metallic structure 29 in the form of an interdigital capacitor that is mounted directly on the plastic surface which is produced using MID technology. This exemplary embodiment has a simple design and requires a cost-effective method of manufacture.

In addition, FIGS. 3 through 7 indicate that the fluid may gain access to the interior of hollow member 20 through at least one inlet opening 21, as shown in FIG. 2.

Finally, FIG. 8 illustrates an alternative embodiment of the fluid sensor 5 shown in FIG. 2, which includes not only a first sensor element having a sensing area 50 according to one of the exemplary embodiments shown in FIGS. 3 through 7, but also at least one additional sensor element 30 that provides a further measured variable characterizing a physical, in particular electric, and/or chemical, property of the fluid during operation. This measured variable is, for example, a temperature, a thermal or electric conductivity, a dielectric constant, or a viscosity of the fluid. The additional sensor element may be designed as a temperature sensor having a negative temperature coefficient.

Specifically, FIG. 8 shows an area of the inside of hollow member 20 according to FIG. 2, which is provided with an inlet opening 60 that may be identical to one of inlet openings 21 shown in FIG. 2. At least certain areas of additional sensor element 30 are at least temporarily exposed to the fluid through this inlet opening 60. According to FIG. 8, certain areas of the surface of plastic hollow member 20 are provided with conductors 31, which combination is produced from a 2-component injection-molded plastic having a metal-platable component and subsequent currentless or galvanic deposition or subsequent hot stamping. Using an electrically conductive adhesive 32 and conductors that are connected to this adhesive 32, additional sensor element 30 is contactable or controllable via conductors 31. Additional sensor element 30 may be connected to conductors 31 on plastic surface 20 using conventional flip-chip technology. It should be further noted that, for mounting additional sensor element 30, the side of plastic cover 24 facing the inside of hollow member 20 may also be used instead of the inside of hollow member 20.

The MID technology used in the exemplary embodiments discussed above makes it possible to replace p.c. board 13 (shown in FIG. 1) with conductors on a plastic surface, and to also apply capacitance measuring board 11 (shown in FIG. 1) directly onto a plastic surface, in particular the inside of hollow member 20. In addition, additional sensor elements 30 that may be present may also be applied directly on the plastic that has been metal plated in certain areas. This simplifies the layout and connections, and reduces the manufacturing costs of fluid sensor 5.

What is claimed is:

1. A sensor element, comprising:
at least one sensing area that is at least temporarily in contact with a fluid to be tested, the sensing area detecting a measured variable characterizing at least one of a physical property and a chemical property of the fluid;
wherein at least certain portions of the sensing area include one of a metal plating and a metallic structure that is applied directly to a plastic surface.

2. The sensor element as recited in claim 1, further comprising:
a hollow member; and
a base member;
wherein the hollow member and the base member together form a housing that shields the sensing area against disturbances.

3. The sensor element as recited in claim 2, wherein the plastic surface is part of an inner surface of the hollow member, wherein the hollow member is provided with at least one inlet opening for the fluid.

4. The sensor element as recited in claim 2, wherein the base member is provided with a cover facing away from the hollow member.

5. The sensor element as recited in claim 1, wherein the applied metal plating is a structured metal layer.

6. The sensor element of claim 1, wherein the sensing area includes one of a plurality of rods, a plurality of prisms, and a plurality of hollow cylinders at least partially made of plastic and one of superficially metal plated in a form of an interdigital structure and provided with a metallic structure on selected surface areas.

7. The sensor element as recited in claim 6, wherein the sensing area includes one of a pair of rods, a pair of prisms, and a pair of hollow cylinders positioned one of in parallel and concentrically to one another to form a capacitor.

8. The sensor element as recited in claim 6, wherein the surface of at least one of a single rod, a single hollow cylinder, and a single prism includes an insulation layer on top of the one of the metal plating and the metallic structure provided on the plastic surface.

9. The sensor element as recited in claim 1, wherein the sensing area further includes a bracket at least partially made of plastic, the one of the metal plating and the metallic structure being provided on the plastic surface of the bracket.

10. The sensor element as recited in claim 1, wherein the one of the metal plating and the metallic structure is applied to the plastic surface using MID technology.

11. The sensor element as recited in claim 1, wherein at least one of a dielectric constant, an electric conductivity, a thermal conductivity, and a fill level of the fluid in a reservoir is measured by the sensing area.

12. A fluid sensor, comprising:
a first sensor element having at least one sensing area that is at least temporarily in contact with a fluid, the sensing area detecting a measured variable characterizing at least one of a physical property and a chemical property of the fluid; and
an additional sensor element having at least one sensing area for providing an additional measured variable characterizing at least one of a further physical property and a further chemical property of the fluid;
wherein at least certain portions of the sensing area of the first sensor element include one of a metal plating and a metallic structure that is applied directly to a plastic surface.

13. The fluid sensor as recited in claim 12, wherein the additional sensor element includes one of a viscosity sensor element and a temperature sensor element.

14. The fluid sensor as recited in claim 12, wherein the additional sensor element is electrically conductively connected to the one of the metal plating and the metallic structure applied to the plastic surface, and wherein the additional sensor element is at least one of electrically controllable and electrically readable from the one of the metal plating and the metallic structure.

15. The fluid sensor as recited in claim 14, wherein one of the metal plating and the metallic structure is one of a conductor and an interdigital capacitor.

16. The fluid sensor as recited in claim 14, wherein the additional sensor element is connected to one of the metal plating and the metallic structure by an electrically conductive adhesive.

17. The fluid sensor as recited in claim 14, wherein the additional sensor element is connected to one of the metal plating and the metallic structure on the plastic surface using flip-chip technology.

18. The fluid sensor as recited in claim 12, wherein the additional sensor element is at least temporarily in contact with the fluid via an inlet opening.

19. The fluid sensor as recited in claim 12, wherein one of the metal plating and the metallic structure is applied to the plastic surface using MID technology.

20. The sensor element as recited in claim 2, wherein the at least one physical property is an electric property, and wherein the disturbances include at least one of mechanical effects and electromagnetic fields.
